(19) United States
(12) Patent Application Publication
(10) Pub. No.: US 2026/0244395 A1
(43) Pub. Date: Aug. 20, 2026

(54) SYSTEMS AND METHODS FOR AUDIO BUS MANAGEMENT

(71) Applicant: Tymphany HK Limited, Hong Kong (HK)

(72) Inventors: Dimitar Georgiev GRITSNELOV, Taipei City (TW); Gavin JONES, Taipei City (TW); Nathan DAVIES, Taipei City (TW)

(21) Appl. No.: 19/371,961

(22) Filed: Oct. 28, 2025

Related U.S. Application Data
(60) Provisional application No. 63/760,928, filed on Feb. 20, 2025.

(51) Int. Cl. G06F 3/16

(52) U.S. Cl. CPC G06F 3/165

(57) ABSTRACT

An audio system for a vehicle includes a central unit configured to communicate audio signals over at least one bus, which may be a master bus including a plurality of nodes; a master transceiver; a digital signal processor (DSP); and a controller. The controller may be configured to monitor a connection status of a removable sub node during operation of the audio system. In response to the connection status indicating that the removable sub node is connected, the controller may be configured to cause the DSP to switch to a first state. In response to the connection status indicating that the removable sub node is disconnected, the controller may be configured to cause the DSP to switch a second state. The first state and the second states may correspond to different configurations for the audio signals communicated by the DSP.

### CROSS REFERENCE TO RELATED APPLICATIONS

This application claims priority of U.S. Provisional Application No. 63/760,928 filed on Feb. 20, 2025 under 35 U.S.C. § 119(e), the entire contents of which are hereby incorporated by reference.

### BACKGROUND OF THE INVENTION

### Field of the Invention

The present invention related to audio systems and, more particularly, to a system and method for audio bus management in a vehicle audio system.

### Description of the Related Art

Modern automotive and industrial audio systems often involve the transmission of high-fidelity audio signals with control signals through various devices such as microphones, sensors, amplifiers, speakers, and multimedia systems. These systems often rely on two-wire communication methods such as Inter-IC Sound (I²S), time division multiplexing (TDM), or proprietary communication buses. However, these methods can involve complex wiring harnesses, increased system cost, and limitations in scalability, distance, and EMI (Electromagnetic Interference) performance.

To address these challenges, digital audio transceivers and buses such as Analog Devices' Automotive Audio Bus (A²B™) have been developed. A²B is a high-bandwidth, bidirectional, serial communication bus that allows the transmission of digital audio, control data, and power over a single, unshielded twisted pair (UTP) cable. A²B transceivers can be configured in either master or slave, as in a master-slave network, where a central processor (the master) can communicate with multiple peripheral devices (sub nodes and/or slaves) such as digital microphones or amplifiers. This topology significantly reduces cabling complexity and weight, which can be important to automotive applications.

Despite the benefits offered by A²B and similar technologies, existing implementations still face challenges related to adaptability and scalability. For example, the existing A²B transceivers and bus systems have a limited ability to enable dynamic modification of continuous playback in response to changing sub nodes or peripheral devices.

### SUMMARY OF THE INVENTION

The present inventors have recognized a need for improved systems and methods for managing audio buses that enhance flexibility, reliability, and integration with heterogeneous audio and control subsystems.

In accordance with certain exemplary aspects of the invention, an audio system for a vehicle includes a central unit configured to communicate audio signals over at least one bus, the at least one bus comprising a master bus, wherein the master bus comprises a plurality of nodes; a master transceiver corresponding to a main node of the plurality of nodes; a digital signal processor (DSP) configured to communicate the audio signals with the master transceiver and a plurality of sub nodes of the plurality of nodes, the plurality of sub nodes comprising a removable sub node; and a controller in communication with the central unit, the master transceiver, and the DSP, wherein the controller is configured to monitor a connection status of the removable sub node during operation of the audio system. In response to the connection status indicating that the removable sub node is connected, the controller is configured to cause the DSP to switch to a first state, and in response to the connection status indicating that the removable sub node is disconnected, the controller is configured to cause the DSP to switch a second state, the first state and the second states corresponding to different configurations for the audio signals communicated by the DSP.

In accordance with another exemplary aspect to the present invention, a method for a vehicle audio system includes communicating, via a central unit, audio signals over at least one bus, the at least one bus comprising a master bus, wherein the master bus comprises a plurality of nodes, wherein a main node of the plurality of nodes comprises a master transceiver; communicating, via a digital signal processor (DSP), the audio signals with the master transceiver and a plurality of sub nodes of the plurality of nodes, the plurality of sub nodes comprising a removable sub node; and monitoring, via a controller in communication with the central unit, the master transceiver, and the DSP, wherein the controller is configured to monitor a connection status of the removable sub node during operation of the audio system. In response to the connection status indicating that the removable sub node is connected, the controller is configured to cause the DSP to switch to a first state, and in response to the connection status indicating that the removable sub node is disconnected, the controller is configured to cause the DSP to switch a second state, the first state and the second states corresponding to different configurations for the audio signals communicated by the DSP.

### BRIEF DESCRIPTION OF THE DRAWINGS

The accompanying drawings, which are incorporated in and constitute a part of this disclosure, illustrate various disclosed embodiments. In the drawings:

FIG. 1 is a diagram illustrating an example audio system, consistent with some previous systems;

FIG. 2A is a diagram illustrating an example audio system, consistent with some disclosed embodiments;

FIG. 2B is a diagram illustrating an example audio system with a controller in communication with a master transceiver and a DSP, consistent with some disclosed embodiments;

FIG. 3 is a flowchart illustrating an example of operating an audio system with a removable sub node, consistent with some disclosed embodiments; AND

FIG. 4 is a flowchart illustrating a process for implementing an audio system in a vehicle, consistent with some disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

Disclosed systems and methods are intended to address limitations in conventional audio bus architectures (e.g., A²B), particularly regarding adaptability and scalability in distributed audio environments. To date, dynamic reconfiguration when removable peripheral devices are introduced or removed has presented numerous challenges. To overcome these challenges, disclosed embodiments describe an audio system making use of a controller external to the vehicle's central unit (e.g., head unit or infotainment system) to support dynamic node changes during operation. According to some embodiments, the controller may monitor the connection status of removable sub nodes and coordinate with a digital signal processor (DSP) to switch between predefined control logic states, enabling real-time reconfiguration of audio signal paths without disruption to audio playback. The disclosed embodiments provide dynamic audio signal management suitable for modern vehicle audio systems.

As used herein, a master node and/or main node may refer to the central or primary controller in a hierarchical or distributed system that manages and coordinates the activities of subordinate nodes (such as slave or sub nodes). As used herein, a main node may include nodes which act as parents to other nodes. For example, a main node may be part of a vehicle's central unit, and/or associated with a device downstream of the central unit.

It should be understood that the terms sub nodes, slaves, sub node transceivers, slave transceivers and the like may be used interchangeably with respect to the disclosed embodiments. A sub node may refer to a component or device within a larger network or system that performs specific tasks, communicates with other nodes, and may operate under the coordination of a central or parent node. As used herein, slaves and/or slave transceivers may act as sub nodes in the system, and/or may act as nodes downstream of the sub nodes.

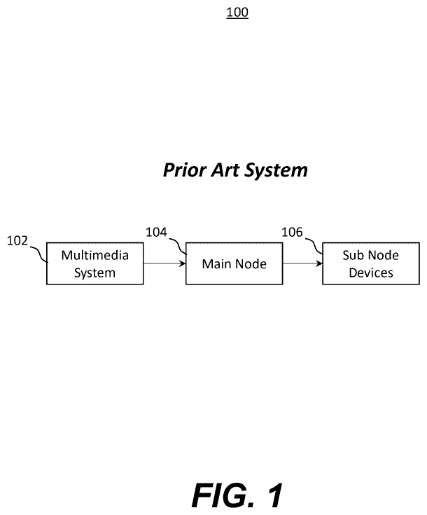

FIG. 1 is a diagram illustrating example audio system 100, consistent with some previously available systems. Multimedia system 102 may produce audio signals, control signals, or any combination therein. These signals are communicated with main node 104, which may be a transceiver (e.g., A²B transceiver). Main node 104 is used to communicate, through a bus, with sub node devices 106 throughout a vehicle. Main node 104 communicates and distributes the control and audio signals. Main node 104 is generally a part of multimedia system 102, rather than a physically separated component.

Sub node devices 106 include a plurality of nodes corresponding to various peripheral devices associated with the audio system. Information between multimedia system 102, main node 104, and the peripheral devices may travel upstream back toward multimedia system 102 or downstream toward the peripheral devices. Devices associated with the audio system may refer to any device configured to communicate audio or control signals with multimedia system 102. For example, such devices may include sensors (e.g., accelerometers, pressure sensors, motion sensors) or audio devices (e.g., I/O devices, microphones, speakers).

As shown in FIG. 1, multimedia system 102 communicates all control and audio signals directly through main node 104. In this configuration, when a sub node device 106 is removed or replaced, main node 104 cannot dynamically update the audio streams during operation (such as live audio playback). Instead, multimedia system 102 may either cease operation due to an error or continue with incorrect playback. Any system reconfiguration must be performed at the level of multimedia system 102 and typically requires a full system reboot to accommodate changes in sub node devices 106. Therefore, even if previous systems allow for dynamic reconfiguration of audio streams, such adjustments would require reprogramming at the level of multimedia system 102, which is impractical in real-world scenarios. For example, in a vehicle audio system, adding or removing a removable sub node device presents significant challenges: removing and reattaching the device can result in errors or faulty playback, as the existing multimedia system 102 lacks prior knowledge of the device and cannot adjust audio streams dynamically.

Disclosed embodiments provide systems and methods that significantly improve upon existing architectures (e.g., audio system 100) by enabling greater flexibility for dynamic adjustments during operation. Unlike conventional audio bus systems, which typically involve a full system reboot or manual reprogramming to accommodate changes in sub node devices, the disclosed embodiments introduce a separate controller in communication with a digital signal processor (DSP) that actively monitors the connection status of sub node devices, including removable sub nodes. This allows the system to automatically reconfigure audio signal paths and control logic states in real time, without interrupting ongoing audio playback or initiation of user intervention. As a result, the system can seamlessly integrate or remove peripheral devices, such as speakers, microphones, or sensors, while maintaining reliable and error-free operation. These improvements support dynamic node expansion, segmented audio routing, and multi-path communication, thereby enhancing adaptability, efficiency, performance, and fault tolerance in distributed audio environments, particularly in automotive applications.

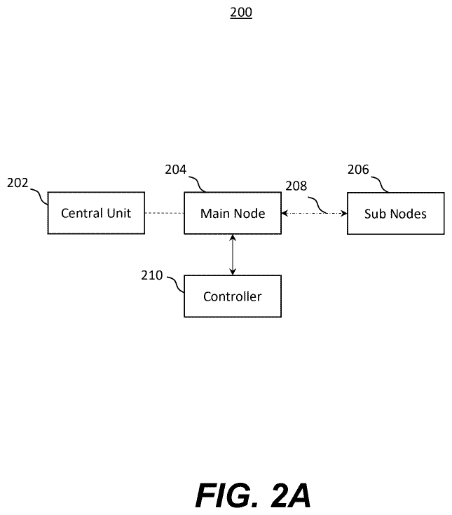

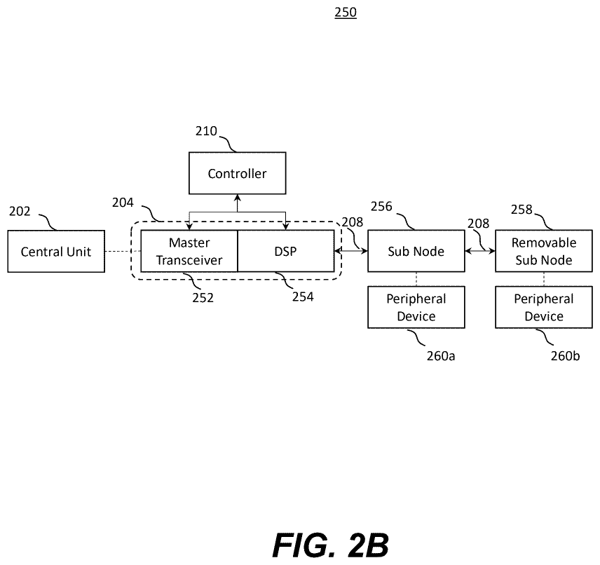

In contrast to the previous art system of FIG. 1, FIG. 2A is a diagram illustrating example audio system 200, consistent with some disclosed embodiments. Central unit 202 may be configured to communicate one or more audio signals and/or control signals through main node 204 to sub nodes 206 over master bus 208. Controller 210, separate from central unit 202, may communicate directly with main node 204 to provide control signals that enable modification of audio signals associated with sub nodes 206.

Central unit 202 may refer to a central electronic device in a vehicle that functions as the primary interface and control system for multimedia, audio playback, navigation, or related infotainment functions. For example, central unit 202 may refer to a head unit, car stereo, audio system, infotainment system, multimedia system, dashboard control unit, central media system, central system processing unit, smart amplifier, or any module or device configured to act as a central device in a vehicle system capable of handling audio signaling. Central unit 202 may include one or more user interface components such as a touchscreen display, physical buttons, rotary dials, or voice control modules, and may be integrated into the vehicle's dashboard or instrument panel.

Central unit 202 may include processing circuitry configured to manage audio sources, signal routing, user preferences, and system diagnostics. Central unit 202 may communicate with other vehicle subsystems via communication buses such as controller area network (CAN), media-oriented systems transport (MOST), A²B, or ethernet, and may also support wireless protocols including Bluetooth®, Wi-Fi®, or cellular LTE. For example, central unit 202 may receive audio input from a smartphone via Bluetooth, process the signal, and transmit the resulting audio to various speaker zones within the vehicle. In another example, central unit 202 may execute voice assistant software to allow a driver to initiate phone calls, adjust media playback, or control vehicle functions through natural language commands. Central unit 202 may further include storage media, navigation modules, or connectivity to cloud-based services, and may operate as a master controller in distributed audio systems comprising amplifiers, microphones, peripheral transceivers, etc.

In some embodiments, central unit 202 may include some functionality and/or structure similar to that of multimedia system 102 in FIG. 1. In some embodiments, central unit 202 may functionally and/or structurally differ from multimedia system 102. For example, central unit 202 may not include main node 204 or any other various controllers or components.

Sub nodes 206 may link to master bus 208 and include, for example, peripheral devices (e.g., audio devices or sensors) and/or sub nodes configured to communicate with peripheral devices, or any combination therein. For example, sub nodes 206 may include secondary or auxiliary nodes that are logically or physically connected downstream of a master node. Sub nodes may include sub nodes or may interface with peripheral devices. For example, peripheral devices may include sensors (e.g., accelerometers, pressure sensors, motion sensors) or audio devices (e.g., I/O devices, microphones, speakers).

Sub nodes 206 may be configured at any node (e.g., intermediary or intervening nodes) along master bus 208. For example, one device may be linked through an intermediary node on master bus 208. The intermediary node may be a sub node and/or a smart node, and/or a dumb node. A smart node may refer to any active node in the system. A dumb node may refer to a node in which the signals are simply relayed through the node. For example, the dumb node may include a simple electronic device interfacing with the audio system wires, or the dumb node may include a crossing of wires, acting as a node.

Central unit 202 may be configured specifically to interact with main node 204. For example, central unit 202 may include main node 204 as one or more electronic boards integrated into central unit 202, allowing central unit 202 to act as a master transceiver for the network of nodes in example audio system 200. Main node 204 may initialize and configure its downstream network of nodes, enumerating each downstream sub node along the chain or network. Main node 204 may be supplemental to central unit 202. For example, central unit 202 may include a master transceiver (e.g., A²B transceiver and A²B audio bus operable using software such as Sigma Studio©) or master device configured to communicate information through main node 204.

Central unit 202 may be configured to generate audio and/or control signals. Audio signals may include any signals associated with audio devices or sensors in the vehicle, for example, accelerometers, pressure sensors, motion sensors, I/O devices, microphones, speakers, etc. Central unit 202 may also communicate control signals that may include control signals for synchronization, timing, downstream peripheral device information, communication channels, registers, etc.

Master bus 208 may comprise a plurality of nodes, which may refer to any nodes corresponding with main node 204 and/or sub nodes 206. The plurality of nodes may correspond to a device in central unit 202, main node 204, sub nodes 206, or downstream peripheral devices, and may include master or sub nodes, or associated sub-node devices such as microphones, amplifiers, or sensors. The plurality of nodes may be configured on master bus 208 to form linear, daisy-chained topology using, for example, an unshielded twisted pair (UTP) cable that may carry power, clock, data, and/or control signals between nodes. For example, in a daisy chain configuration, each sub node may be configured to receive downstream frames from its immediate upstream node and to transmit upstream frames toward the master transceiver.

The configuration of controller 210 and main node 204 is described in further detail with respect to FIGS. 2B to 4.

FIG. 2B is a diagram illustrating an example audio system 250 with controller 210 in communication with master transceiver 252 and DSP 254, consistent with some disclosed embodiments. Certain features of the system of FIG. 2B are shared with the audio system 200 in FIG. 2A, and unless otherwise stated, the description above remains relevant to the shared features.

Central unit 202 may be configured to communicate audio and/or control signals via master bus 208 with a plurality of nodes including sub node 256 (i.e., an intermediary or intervening node), removable sub node 258, and peripheral devices 260a, 260b. Central unit 202 may communicate directly with master node 204. In some embodiments, master node 204 is comprised in central unit 202. In some embodiments, master node 204 is comprised separate from central unit 202. In any case, audio and control signals may be communicated through master node 204 to devices associated with master bus 208.

In FIG. 2B, main node 204 is illustrated as comprising both master transceiver 252 and DSP 254. This arrangement is an example and is not intended as limiting. Master transceiver 252, DSP 254, and central unit 202 may be implemented as a single node with interconnected circuitry (such as integrated circuit boards), as separate nodes, or in any combination thereof. For example, in a vehicle's audio system, the circuit boards associated with central unit 202, master transceiver 252, and DSP 254 may be physically separated and considered distinct nodes within the network. In another example, controller 210, master transceiver 252, and DSP 254 may be comprised in main node 204, separate from central unit 202. This architectural flexibility may enable system designers to tailor the physical and logical configuration of the audio system to specific requirements, supporting distributed, modular, or integrated implementations as desired.

Master transceiver 252 may be a communication device configured to initiate, control, and/or manage data transmission over a serial audio bus within a vehicle audio system. For example, master transceiver 252 may be an A²B transceiver or a functionally equivalent device capable of serving as a node (typically an initiating node) in a daisy-chained or multi-drop digital audio network. A multi-drop digital audio network may refer to a communication system where multiple audio devices are connected to a shared bus, allowing them to communicate digital audio signals through coordinated arbitration and dynamic routing mechanisms. The transceiver is operatively coupled to one or more sub nodes 256 (e.g., slave nodes), optionally including removable sub node 258, via a physical medium such as, for example, an unshielded twisted pair (UTP) cable, over which audio signals, control signals (e.g., clock signals), or power may be transmitted. Such sub nodes may communicate audio and control signals with one or more peripheral devices 260a, 260b (e.g., audio devices or sensors). The transceiver may be integrated into central unit 202, central processor, or audio gateway module and can be configured to enumerate, synchronize, and manage downstream sub nodes (e.g., sub node 256, removable sub node 258, etc.) in the network. For example, master transceiver 252 may establish a timing reference for master bus 208, assign logical addresses to sub nodes 256 and/or peripheral devices 260a, 260b (e.g., sensors, microphones, amplifiers, or speaker modules), and handle bidirectional communication through time-division multiplexing (TDM). In certain implementations, the transceiver may be configured to detect faults, initiate diagnostics, and adapt the bus configuration based on system conditions or user input, among other things.

Master transceiver 252 may implement one or more digital audio protocols, including but not limited to inter-integrated circuit (I²C), Inter-IC Sound (I²S), or TDM, depending on system architecture and performance requirements. The transceiver may communicate through a serial peripheral interface (SPI) and include multiplexing to distribute audio and control signals across different channels. In embodiments utilizing I²S or TDM, master transceiver 252 may generate timing signals such as bit clock (BCLK), word select (WS), and frame synchronization signals, which may define the data structure and timing for downstream slave audio devices such as digital microphones, amplifiers, or digital to analog converters (DACs). For example, in a TDM-based system, the transceiver may allocate discrete time slots to multiple slave devices within a shared serial data stream, allowing for the simultaneous transport of multi-channel audio. In I²S implementations, the transceiver may communicate with individual point-to-point devices using a dedicated clock and data line. In both cases, the transceiver may be configured to maintain synchronization of its affiliated devices, initializing connected devices, and optionally managing mute, gain, or error correction functions, among other things.

When used in conjunction with other systems such as A²B, master transceiver 252 may additionally provide power and handle automated enumeration and topology discovery over single physical interfaces. Accordingly, the transceiver may act as a central coordinating entity for timing, data framing, and bus integrity in a variety of serial digital audio architectures employed in vehicle environments.

In FIG. 2B, master transceiver 252 is located at the main node of master bus 208. However, this is not intended as limiting, and according to some embodiments, master transceiver 252 may be located at any node in the plurality of nodes. For example, master transceiver 252 may be positioned at an alternative node in master bus 208, with additional nodes or target nodes located downstream of master transceiver 252 as determined moving along the bus away from central unit 202.

In some embodiments, master transceiver 252 may be configured to communicate audio signals directly with central unit 202. For example, master transceiver 252 (or controller 210) may be positioned as a first node or initial node of master bus 208 and audio and control signals may pass directly from central unit 202 through master transceiver 252, which may allocate the signals through communication channels to each node, along master bus 208 or any sub nodes therein. In another example, master transceiver 252 may be positioned at another node (i.e., not the initial node) on master bus 252 and may communicate directly with central unit 202 to communicate audio signals for further downstream audio devices. In this way, master transceiver 252, participates with the central unit 202 in coordinating communication of audio and control signals through communication channels in the network.

In some embodiments, master transceiver 252 may be configured to recognize the presence of removable sub node 258 and adjust signaling to accommodate for demands of removable sub node 258. For example, in an A²B audio system, an A²B transceiver (e.g., a transceiver in central unit 202) may automatically discover and configure connected slave devices when the system powers up. It may send discovery signals along the bus, assign addresses, and manage each node using embedded I²C communication. If a device is added or removed (e.g., removable sub node 258), the system can detect changes through, for example, signal and response checks.

Removable sub node 258 may refer to any peripheral device or component that can be added to or detached from the audio system without requiring permanent installation. In some embodiments, removable sub node 258 may comprise a removable peripheral device. Examples include speakers (e.g., Bluetooth™ speakers), microphones, sensors, wireless audio modules, or other audio-related devices that connect to the system for specific functions. These sub nodes may be designed for easy replacement, upgrade, or temporary use, allowing users to customize or expand the audio system as needed. In some embodiments, removable sub node 258 may correspond to the last node of master bus 208, which may limit or avoid potential disruption to audio signaling. In some embodiments, removable sub node 258 may be located at an intermediary node on master bus 208. For example, this configuration may be possible where master bus 208 is configured to provide a bypass to prevent signal disruption upon detachment of removable sub node 258.

In addition to master transceiver 252, master node 204 may include DSP 254 for processing audio signals, and/or controller 210 for generating control signals for reconfiguring downstream sub nodes, among other things.

Central unit 202 may include DSP 254 to enable efficient and distributed audio signal processing across multiple zones or components within the vehicle. DSP 254 may also be located in a central unit, such as a telematics control unit (TCU), or an amplifier module, and may interface with a communications bus (e.g., master bus 208) or network that connects remote audio nodes throughout the vehicle. The communications bus may thus be configured to carry digital audio data, control commands, synchronization signals, etc. between DSP 254 and peripheral devices 260a, 260b, such as microphones, speakers, amplifiers, and sensors. Notably, although DSP 254 is described as included with central unit 202, DSP 254 may be a component fully incorporated within central unit 202, partially incorporated, or fully distinct from central unit 202, as desired for a particular configuration.

According to some embodiments, DSP 254 may be configured to receive audio input from remote microphones, process signals for beamforming, noise reduction, and echo cancellation, and then transmit the processed audio to speaker amplifiers or other output devices. DSP 254 may, in addition or alternatively, be configured to support dynamic audio routing, channel management, and zone-specific effects based on input from connected components. For example, DSP 254 may be configured to apply time-domain and frequency-domain algorithms to the input signals. For example, DSP 254 may be configured to perform Fast Fourier Transform (FFT) operations to convert signals into the frequency domain, where noise profiles can be analyzed and suppressed using adaptive filtering techniques. In beamforming applications, DSP 254 may be configured to process signals from multiple spatially separated microphones to isolate sound from a particular direction (e.g., a driver's voice) while reducing interference from other sources. Echo cancellation may be implemented using, for example, adaptive filters that model and subtract feedback paths between speakers and microphones, which is especially useful in full-duplex communication scenarios. Such analyses of signals from microphones and sensors may be useful for noise cancellation, such as reducing the effects of traffic noise on the audio system.

DSP 254 alone or in combination with other components of central unit 202 (or other central unit) may be configured to handle multiple audio channels simultaneously, enabling parallel or sequential processing of input and output signals across the vehicle's audio system. Each audio channel may correspond to a different signal from a particular device (e.g., audio device or sensor), and may be assigned to a dedicated processing pipeline within DSP 254 (or multiple channels may be processed simultaneously or together). DSP 254 may be configured to apply a series of filters to each channel, including high-pass filters to remove low-frequency noise (e.g., road rumble), low-pass filters to eliminate high-frequency interference, and band-pass filters to isolate speech or music content. In multi-channel configurations, DSP 254 may also be configured to perform channel mixing, splitting, or steering to support spatial audio rendering or adaptive playback strategies. Adaptive filtering techniques, such as Wiener or LMS (least mean squares) filters, may be employed to continuously refine the signal processing based on dynamic acoustic conditions within the vehicle cabin. For noise cancellation or beamforming, the DSP may analyze the phase and amplitude relationships across channels, adjusting filters in real time to improve the signal to noise ratio and overall audio quality. This filtering may be performed in both time and frequency domains, and may be controlled via software or hardware, including using feedback from environmental sensors or microphones.

DSP 254 may include or be in communication with an amplifier and one or more codecs, located, for example, in or near main node 204, for processing audio signals or converting them between analog and digital signals. The one or more codecs may be configured to perform analog-to-digital and digital-to-analog conversions, while the amplifier may be configured to boost signal strength, thereby enabling seamless playback, recording, and signal conditioning within the audio system. For example, in addition to signal conversion and amplification, one or more codecs of DSP 254 may be configured to support multiple sampling rates and bit depths, enabling compatibility with various audio formats and system requirements. The one or more codecs may also include integrated digital filters and automatic gain control (AGC) to optimize signal fidelity and dynamic range. DSP 254 may interface with the codec via serial protocols like I²S or TDM, and may use DMA channels to offload data transfer, enabling low-latency and high-throughput audio processing.

In some embodiments, controller 210 may be in communication with central unit 202, master transceiver 252, and DSP 254. In some embodiments, controllers 210 may be directly linked to DSP 254 and master transceiver 252. Controller 210 may be configured to generate control signals for coordinating at least some of the audio signals. For example, controller 210 may communicate the control signals using I²C or SPI, while audio signals may be communicated via I²S directly from central unit 202. This configuration is not intended as limiting, and in some embodiments, the control and audio signals may be mixed and communicated with other protocols may be used. For example, universal asynchronous serial port (UART), general purpose input/output (GPIO), secure digital input output (SDIO), controller area network (CAN), etc. It should be understood that controller 210 may be operable in other types of audio systems with other types of master transceivers, for example, audio video bridging (AVB™) and/or Dante™ systems.

Controller 210 may be configured to initiate or reinitiate master bus 208 using the Discovery Flow as defined in Analog Devices'technical documentation (e.g., for AD243x transceivers), alone or in tandem with master transceiver 252. Controller 210 may monitor system conditions such as connector status, GPIO inputs, or other relevant triggers, and upon determining that removable sub node 258 is included, may issue I²C commands to initiate the appropriate discovery sequence for sub nodes on master bus 208. These commands may include writing to discovery control registers to launch either simple or optimized discovery flows, optionally configuring node addressing, clock roles, or channel maps, and reading status flags to confirm discovery completion and verify node connectivity. For example, controller 210 may utilize the built-in capabilities of A²B transceivers to dynamically extend the audio bus, which may enable the activation of removable sub node 258, driven by master transceiver 252, in response to physical or logical system events, without performing a full system reboot.

In some embodiments, controller 210 may be configured to communicate control signals only through master transceiver 252 or DSP 254, while in some other embodiments, controller 210 may be configured to communicate the audio signals directly with central unit 202. For example, controller 210 may be responsible for coordinating audio signals to or from DSP 254 or master transceiver 252, even where controller 210 does not handle or process the audio signals. For example, controller 210 may be configured as part of master bus 208 in lieu of or in combination with master transceiver 252. This configuration may allow for controller 210 to receive (e.g., directly) and coordinate audio signals and control signals from central unit 202. For example, controller 210 may be configured to use the audio signals and control signals to determine how communication should be coordinated for devices associated with master bus 208. In this way, controller 210 may monitor the connection status of downstream sub node 256 and/or removable sub node 258, enabling reconfiguration of the system on demand.

In some embodiments, DSP 254 may be in communication with controller 210 and master transceiver 252, and may further be configured to communicate at least a portion of the audio signals with master transceiver 252 and a plurality of sub nodes (e.g., sub node 256 and/or removable sub node 258). For example, the portion of audio signals may be downstream audio signals designated by master transceiver 252 and controller 210 as destined for devices associated with master bus 208 (e.g., loudspeakers, etc.).

DSP 254 may handle audio processing, routing, and tuning according to the configuration of master bus 208. This configuration may enable dynamically switching roles and reconfiguring the audio system during operation. With support from controller 210 and/or central unit 202, DSP 254 may adapt its signal routing based on whether removable sub node 258 is present. In practice, this means that DSP 254 may maintain multiple precompiled routing configurations and switch between them automatically, depending on system demands. This approach may increase flexibility and eliminate firmware reloads when the network changes.

In some embodiments, DSP 254 may comprise different states such that when the system detects that removable sub node 258 is connected, controller 210 may instruct DSP 254 to switch to a first state. This state may correspond to a specific configuration for processing and routing audio signals that accounts for the presence of the sub node. Conversely, if the connection status indicates that removable sub node 258 has been disconnected, controller 210 may cause DSP 254 to transition to a second state, which may be configured to handle audio signals without the sub node. Each state may represent a distinct set of parameters and signal paths within DSP 254, ensuring that the audio system can dynamically adapt to changes in network topology. This approach may facilitate integration or removal of peripheral devices, maintaining good audio performance and system reliability without involving manual intervention or system reboot, for example.

DSP 254 may be capable of transitioning from the first state to the second state while maintaining active audio communication with one or more sub nodes. During this process, DSP 254 may update its internal routing tables and signal processing parameters in real time, ensuring that audio streams are redirected or reconfigured without causing interruptions or artifacts during audio playback.

In some embodiments, first and second states of DSP 254 may correspond to distinct, predefined control logic states that are stored in advance within DSP 254, controller 210, or both. These control logic states may be precompiled or preloaded into memory during system initialization, allowing the system to rapidly switch between them as needed. Each control logic state may define a different set of processing rules, routing tables, and operational parameters tailored to specific network topologies or device configurations. When removable sub node 258 is connected or disconnected, controller 210 or DSP 254 may automatically load the appropriate control logic state, enabling immediate and deterministic reconfiguration of the audio signal paths.

Consistent with some embodiments, the predefined control logic states for DSP 254 and/or controller 210 may be loaded into memory during system initialization. These states may be retained throughout the operation of the audio system, allowing controller 210 and/or DSP 254 to rapidly switch between configurations, such as those required when removable sub node 258 is connected or disconnected, without delay. By preloading these control logic states, the system may ensure that processing rules, routing tables, and operational parameters are available for dynamic reconfiguration. This approach may help reduce latency and reduce or eliminate firmware updates or manual reprogramming.

Consistent with some embodiments, DSP 254 may be configured to implement the predefined control logic states as distinct logic branches within its architecture, with each branch corresponding to a different network topology (e.g., or device configuration). These logic branches may include different sets of signal routing rules, processing algorithms, and operational parameters tailored to specific arrangements of sub nodes and peripheral devices. When the system detects a change in network topology, such as the connection or disconnection of removable sub node 258, controller 210 and/or DSP 254 may select and activate the appropriate logic branch, ensuring that audio signals are processed and routed optimally for the current configuration.

Consistent with some embodiments, controller 210 may be configured to select between first and second states of DSP 254 using the predefined control logic, based on real-time system feedback such as error flags or status registers received from master transceiver 252. These error flags and status registers may provide diagnostic information about the current state of the audio network, including connectivity issues, device status, or operational anomalies. Error flags in this context could indicate issues such as a missing or disconnected sub node, communication faults between devices, or unexpected changes in network topology. These flags may help the system detect problems like audio dropouts, misrouted signals, or device failures, allowing controller 210 and DSP 254 to respond by reconfiguring audio routing on demand. By continuously monitoring these signals, controller 210 can promptly determine whether a removable sub node is present or has encountered a fault, and then, for example, trigger DSP 254 to load the appropriate control logic state.

In some embodiments, DSP 254 may be configured to communicate directly with removable sub node 258 to verify its presence within the audio system. This verification process may involve DSP 254 sending periodic polling messages, handshake requests, or status queries over the audio bus to removable sub node 258. For example, controller 210 may interface directly with DSP 254 to perform this function. Removable sub node 258 may respond with identification data or acknowledgment signals, confirming its connectivity and operational status. If DSP 254 receives a valid response, it may update its internal routing tables and enable audio signal transmission to the sub node. Conversely, if removable sub node 258 fails to respond or reports an error, DSP 254 may exclude it from active audio routing and may trigger a reconfiguration of signal paths to maintain system integrity. This direct communication mechanism may allow for real-time detection and management of removable devices, ensuring that only present and functional sub nodes participate in audio playback and processing, thereby enhancing the reliability and adaptability of the audio system.

In some embodiments, DSP 254 may be configured to communicate with sub nodes via master transceiver 252, which may be responsible for tasks such as node enumeration, address assignment, and status reporting. If DSP 254 and/or controller 210 is searching for the presence of a new and/or changed downstream node, or check for errors, DSP 254 and/or controller 210 queries master transceiver 252 (e.g., using the I²C protocol) to access relevant status or error flags. Direct polling or messaging from DSP 254 to individual sub nodes may not be supported in this architecture, allowing master transceiver 252 to perform the function of a central point of communication for control for downstream sub nodes and/or devices. For example, in an A²B system, controller 210 may instruct DSP 254 to check the status of removable sub node 258 by querying master transceiver 252 over I²C. Master transceiver 252 may maintain information about connected nodes and may confirm whether removable sub node 258 is present and operational.

In some embodiments, controller 210 may be configured to continuously monitor the status of the sub nodes associated with master bus 208 (e.g., by utilizing periodic polling or event-driven notifications to track connectivity and performance). Upon detecting a connection error, such as a sub node becoming unresponsive, disconnected, or reporting a fault, controller 210 may analyze the error flags or status registers associated with the affected device. In response, controller 210 may send a command to DSP 254 to automatically reconfigure the audio signals for remaining sub nodes (e.g., sub node 256). For example, when removable sub node 258 is removed suddenly, then controller 210 may rapidly detect the removal and command DSP 254 to immediately redistribute the audio signals to the remaining unaffected sub nodes. This real-time adjustment may involve updating routing tables, modifying channel allocations, or activating redundancy mechanisms to maintain uninterrupted audio playback and system functionality. If such an adjustment were not made, audio fidelity may be lost, as the signals originally going to the missing sub node would be lost from the soundscape.

In some embodiments, upon startup of the audio system, controller 210 may be configured to automatically determine whether each sub node within the network is not present (e.g., removable sub node 258). This initialization process may involve querying status registers, polling device identifiers, or conducting handshake protocols to confirm connectivity. If controller 210 determines that one or more sub nodes are missing or not present, controller 210 may proactively prevent DSP 254 from communication of the audio signals. For example, this prevention can be implemented by disabling specific output channels, muting affected signal paths, or updating DSP 254 routing tables to exclude the absent sub node. By halting audio transmission in such cases, the system may avoid routing errors, audio dropouts, or misallocation of resources, thereby ensuring that only available and properly connected sub nodes participate in audio playback and processing.

In one example using a standard A²B bus architecture, the topology may be strictly daisy-chain. This means that all nodes may be connected in series along the bus, and the integrity of the chain may enable downstream communication with multiple sub nodes. If a mid-chain node is disconnected, the physical connection of the bus may be interrupted, resulting in loss of functionality for the downstream nodes. Conversely, if an end-node (i.e., the last node in the chain) is disconnected, the system may continue to operate with the remaining nodes, as the A²B master transceiver (e.g., master transceiver 252) will enumerate only those nodes that are present and physically connected.

In some embodiments, switches may be used to connect or disconnect nodes. As used herein, a switch may refer to any device, mechanism, or system (e.g., physical, electronic, or software-based) that is capable of altering the connectivity, operational state, or signal path of one or more components (e.g., sub nodes or peripheral devices) within an audio network. A switch may include, but is not limited to, for example, hardware relays, mechanical toggles, electronic switches (such as transistors or solid-state devices), automatic digital switches, programmable logic gates, or software-controlled routines. The switch may operate manually, automatically, and/or in response to digital control signals, and can be configured to connect or disconnect nodes, reroute signals, or change the logical or physical topology of the system. When implementing switches for removable sub nodes (e.g., removable sub node 258) in standard A²B bus architecture, it may be desirable to place such switches at the end of the bus to avoid disrupting communication with other nodes.

In some embodiments, the audio system may include a first switch configured to connect or disconnect removable sub node 258 from master bus 208. This switch may be implemented as, for example, a hardware relay, electronic switch, or software-controlled logic gate, allowing for control over the physical or logical connection of the removable device. By enabling or disabling the connection, the system can dynamically add or remove the sub node from the audio network without initiating a full system reboot. This capability may be useful for managing devices such as portable speakers, microphones, or sensors, which may be temporarily integrated or replaced during operation. For example, the switch may allow controller 210 to automatically detect changes in network topology and instruct DSP 254 to adjust audio streaming of the audio signals. According to some embodiments, controller 210 may directly communicate with the switch to detect this change. For example, removable sub node 258 may comprise electronics which enable reporting a status of the switch (or the switch may directly communicate with removable sub node 258).

In some embodiments, the audio system may comprise a second switch configured to connect or disconnect another sub node (e.g., sub node 256) from master bus 208. This second switch may operate independently of the first, providing further flexibility in managing the audio network. For example, the second switch may allow the system to isolate faulty or inactive sub nodes, perform maintenance, or reallocate resources as needed. For example, the second switch may allow controller 210 to automatically detect changes in network topology and instruct DSP 254 to adjust audio streaming of the audio signals. According to some embodiments, controller 210 may directly communicate with the second switch to detect this change. For example, sub node 256 may comprise electronics which enable reporting a status of the switch (or switch may directly communicate with sub node 256).

According to some embodiments, multiple switches may be used (e.g., the first and second switches). The switches may be controlled by master transceiver 252, DSP 254, and/or controller 210, which may monitor the status of each node and determine when to activate or deactivate the connections. By incorporating multiple switches, the system may support advanced features such as segmented audio routing, redundancy, and fault tolerance, thereby enhancing the overall reliability and adaptability of the vehicle's audio environment.

Controller 210 may be configured to handle dynamic switching between locally powered and bus-powered configurations of master transceiver 252 and/or DSP 254. For example, controller 210 may monitor power availability and control internal power routing logic. In locally powered mode, controller 210 may draw power from, for example, a dedicated supply, offering greater stability and isolation. In bus-powered mode, controller 210 may rely on voltage and/or power supplied through the master bus 208. Controller 210 may be configured to detect voltage thresholds or manage power sequencing, as well as to use integrated power management circuitry, fault detection, and possibly hot-swap support.

In some embodiments, the plurality of nodes associated with master bus 208 may include at least one intermediary node (e.g., sub node 256) configured to communicate audio signals with target nodes such as peripheral devices 260a, 260b. As used herein, an intermediary node may correspond to any node on a master bus that is not a master transceiver or a target node. A target node may correspond to a peripheral node of an audio system (e.g., example audio system 230) that is either in communication with a peripheral device or is part of peripheral device 260a, 260b. In some embodiments, a target node may be affixed to peripheral device 260a, 260b, or a sub node (e.g., sub node 256 and/or removable sub node 258).

It should be understood that a node position (such as sub node 256, target nodes, main node 204, or removable sub node 258) may be any real or relative position of a device in the system. The device in the system may include a slave device (e.g., a sub node transceiver and/or slave transceiver), a master transceiver, a peripheral device, etc. For example, the position may be a particular part of a vehicle (e.g., a console, door, or seat), or the node position may be relative to adjacent nodes or other components of the audio system.

According to some embodiments, an additional node may be added to the first plurality of nodes in master bus 208. The additional node may be positioned between a first and a last node of master bus 208, for example, midway between, or at the last node. The additional node may correspond to a sub node and/or a slave transceiver, a peripheral device, etc. Addition of an additional node may be detected upstream by a controller (e.g., controller 210) and/or master transceiver (e.g., master transceiver 252). Upon recognition of the change, the master transceiver or controller may re-initialize master bus 208, reassigning addressing and channel configurations for audio and control signals communications for associated devices.

It should be understood that system architecture, such as that shown with respect to FIG. 2B, may support extensive expansion, for example through additional master transceivers and daisy chaining configurations, the total audio and control data transmitted across any master bus may be restricted by maximum bandwidth constraints (e.g., the bandwidth constraints defined by a master transceiver and/or A²B protocol). To mitigate the risk of master bus saturation and maintain reliable data transmission, signal processing operations may be performed locally at each DSP level (e.g., in DSP 254). This distributed processing approach may reduce bandwidth demand on the master buses and support scalable system performance across multiple bus domains. Furthermore, a distributed DSP topology may enhance overall system efficiency by enabling each DSP to perform localized signal processing and routing. This configuration may allow master buses to carry a greater volume of audio and control data compared to a centralized DSP architecture (e.g., a DSP housed in the head unit), thereby improving scalability and performance in complex audio applications.

The audio system may include different audio zones in a vehicle, for example. In some embodiments, master bus 208 may be located in a first physical location in the vehicle, and a second master bus may be located in a second physical location in the vehicle different from the first physical location. Both master buses may be configured by controller 210 and/or central unit 202. For example, master bus 208 may be located in the console/dashboard of the vehicle, and the second master bus may be located in the doors. Master bus 208 may establish a first audio zone in the vehicle and the second master bus may establish a second audio zone in the vehicle. For example, each audio zone may represent a different part of the vehicle with different audio characteristics.

In digital audio systems employing transceivers such as those used in A²B transceivers and A²B buses (particularly two-wire systems), two primary timing signals, bit clock (BCLK) and left-right clock (LRCLK), may be implemented to synchronize audio data transmission between components. The BCLK may correspond to a rate at which individual bits of audio data are transmitted to maintain proper serialization and deserialization across the audio bus. LRCLK, also known as the word-select or frame-sync signal, may, for example, toggle at the audio sample rate and delineate the boundaries of left and right (or other) channel audio data in stereo streams. For example, in TDM audio modes, LRCLK may mark the beginning of a frame that may contain multiple audio channels, not just stereo. For example, in a traditional A²B system, the master transceiver typically generates both BCLK and LRCLK, distributing them along the bus to, for example, maintain timing coordination among connected nodes, including DSPs, amplifiers, and codecs. Accurate phase alignment of LRCLK and BCLK is desirable for maintaining audio fidelity and channel coherence, especially in systems involving multiple nodes distributed across the vehicle. For example, sub nodes may be configured to accept BCLK and LRCLK as input signals, synchronizing their internal clocks to the master's timing through phase-locked loops (PLL) or clock recovery circuits. Each component of controller 210, master transceiver 252, and DSP 254 may be capable of using BCLK and LRCLK for synchronizing clocks between components, or with other audio system components (e.g., components of example audio system 250), such as central unit 202.

In some embodiments, a clock (e.g., a crystal oscillator) may be used for generating a reference signal for deterministic timing of control signals from controller 210 and the audio signals between controller 210, DSP 254, and master transceiver 252. Using a separate source for the clock reference signals may help provide reliable system performance and avoid potential lag or delays due to system processing.

Consistent with some embodiments, the clock reference signal may be relayed through at least one switch for example, to establish at least one loopback between any combination of master transceiver 252, DSP 254, and controller 210 for synchronizing the audio signals or the control signals. In other embodiments, loopbacks may not use a switch. For example, a direct connection of BCLK_In to BCLK_Out on DSP 254 may be implemented in lieu of switch usage. Clock loopbacks may be implemented as external loopbacks that initiate from a device pin, connect to other device pins, and then loop back to another pin of the first device.

In some embodiments, synchronization of the clock reference signal may be achieved through hardware-based timing alignment, without the need for digital signal processing. This may involve, for example, distributing a stable clock signal, such as one generated by a crystal oscillator, directly to relevant devices via dedicated lines or loopbacks. These hardware-level connections may allow devices to align their timing based on physical signal edges (e.g., rising or falling clock edges), to enable deterministic synchronization with lower computational cost. This may allow validating clock phase alignment across the devices, using PLLs or delay-locked loops (DLLs) for adjustments, thereby synchronizing all devices to allow for deterministic timing of audio and control signals relative to a common reference clock signal.

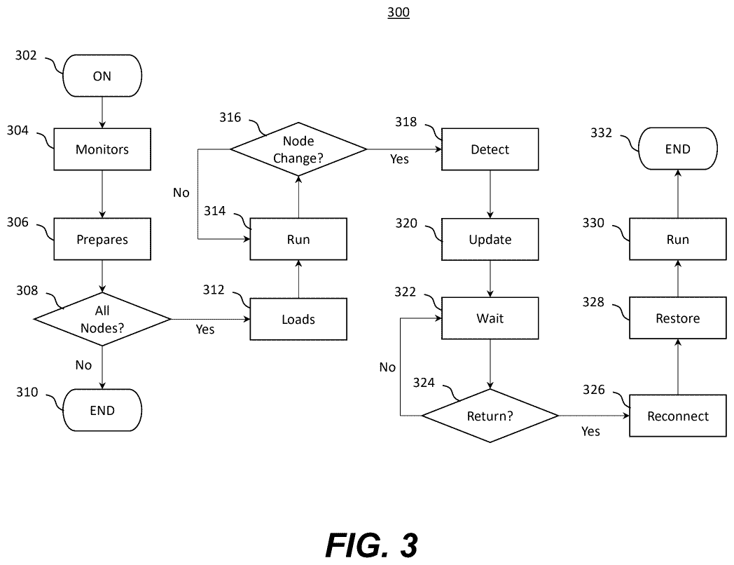

FIG. 3 is a diagram illustrating an example of operating audio system 300 with a removable sub node, consistent with some disclosed embodiments. Audio system 300 may operate using some of the audio system components of audio system 200 and/or audio system 250 from FIGS. 2A-2B. It should be understood that audio system 300 is merely an example implementation of embodiments disclosed herein and is not intended to be limiting.

At step 302, upon activation of the vehicle audio system, the process may commence with the system being powered on. This initialization step helps to ensure that all hardware components, including the central unit, master transceiver, digital signal processor (DSP), and controller, are energized and prepared for subsequent monitoring and signal processing operations. The system ON state may establish the baseline for continuous operation and readiness to manage dynamic changes in the audio network.

In monitor step 304, following system activation, the controller (e.g., controller 210 in FIG. 2B) may enter a monitoring state. In this mode, the controller may continuously oversee the operational status of nodes connected to the master bus, including both fixed and removable sub nodes (e.g., removable sub node 258 in FIG. 2B). For example, the controller may monitor A²B bus via I²C. The controller's monitoring function is critical for detecting changes in network topology, such as the addition or removal of peripheral devices, and for maintaining system integrity throughout operation.

At step 306, the system may transition to a preparation phase, wherein the controller and DSP initialize communication protocols, load necessary configurations, and synchronize their operational states. For example, the DSP may prepare to load preestablished A²B schematics based previous node topology. This preparation may ensure that the audio system is configured to deliver good performance and is capable of responding to dynamic changes in node connectivity, as described in the preceding sections of this specification.

At step 308, the controller may verify whether all expected nodes, including any removable sub nodes, are present and properly connected to the master bus. This verification may help determine whether the system can proceed with standard audio processing or if adjustments are required due to missing or disconnected devices. If all nodes are not present, an error may be generated, resulting in end step 310, which may end the startup or operation.

At step 312, if all nodes are confirmed present, the controller may proceed to load the appropriate data and configuration settings required for the DSP and other system components. This step helps ensure that audio signal routing, processing parameters, and control logic are tailored to the current network topology, enabling seamless management of audio signals across the distributed system.

At step 314, with the system configured, the DSP may initiate real-time processing and distribution of audio signals throughout the network through normal playback. The DSP may manage audio playback and routing, directing signals to various sub nodes and peripheral devices in accordance with the loaded configuration, and maintaining high-fidelity audio performance.

At step 316, the controller may continuously monitor for changes in node status. If no change is detected, the system may maintain its current operational state (e.g., continuing step 314), and the DSP may continue to process audio signals. If a node change is detected, such as, for example, the undocking or removal of a removable sub node (e.g. removed dockable speaker node), the controller may initiate a change management routine to adapt the system to the new topology.

At step 318, upon detecting a change in node status, the controller may identify the specific alteration in the network, such as which node has been removed or added. This detection may trigger a reconfiguration process, allowing the system to adapt to the new arrangement and maintain uninterrupted audio operation.

At step 320, the controller may update the system configuration to reflect the detected node change. This may involve, for example, modifying DSP routing tables, disabling channels associated with the removed node, adjusting control logic to ensure continued reliability and performance of the audio system, etc. For example, the DSP may switch to a fallback configuration that reflects the removed sub node.

At step 322, after updating the system, the controller may enter a waiting state. During this period, the controller may periodically check for the reattachment of the removable sub node, ensuring that the system is prepared to respond promptly to any changes in network status.

At step 324, the controller may determine whether the previously removed sub node has been reattached. If not, the system continues to wait (e.g., returns to wait step 322). If the sub node is detected, the controller may initiate a reconnection sequence to restore full system functionality.

In reconnect step 326, in response to detecting the return of the removable sub node, the controller may re-establish communication with the device. This step may involve re-enumerating the node and updating routing tables.

At step 328, the controller may restore the original system settings and configurations that were in place prior to the node's removal. This restoration may ensure that the audio system returns to its optimal operational state, with all nodes functioning as intended. For example, the DSP may return to the full audio configuration.

At step 330, with the original settings restored and all nodes reconnected, the DSP may resume normal audio signal processing. The process concludes at step 332 with the system fully restored and all nodes, including the previously removed sub node, actively participating in audio signal management. The audio system remains ready to repeat this process as needed, ensuring ongoing adaptability and reliability to on demand changes in the audio system.

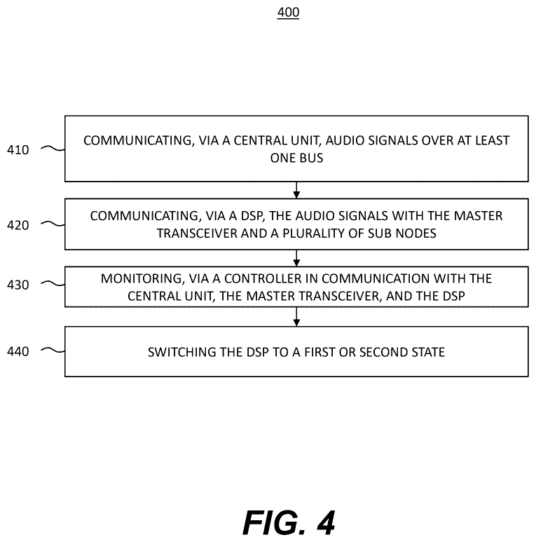

FIG. 4 is a flowchart illustrating process 400 for implementing an audio system in a vehicle, consistent with some disclosed embodiments. Process 400 relates to a method for improving flexibility and adaptability of an audio system. Process 400 may implement any functions, components, and combinations thereof, as presented in any of FIGS. 2A-3 or described previously. For example, process 400 may implement controller 210 of FIGS. 2A-2B for performing any of the steps of process 400. Alternatively, any of the devices or components discussed above may be implemented alone or in combination for carrying out the steps of process 400. The components of FIGS. 2A-3 are incorporated by reference with respect to process 400.

Step 410 of process 400 may include communicating, via a central unit, audio signals over at least one bus. The at least one bus may be configured to include a master bus. The master bus may include a plurality of nodes. A central unit (e.g., central unit 202) may be configured to communicate audio and control signals along the master bus (e.g., master bus 208). The plurality of nodes may be configured to include intermediary nodes, target nodes, or master transceivers, such as master transceiver 252 (e.g., as a part of a main node). The nodes may be sub nodes and/or slave transceivers to the central unit and include peripheral devices.

Step 420 of process 400 may include communicating, via a DSP, the audio signals with the master transceiver and a plurality of sub nodes. The DSP (e.g., DSP 254) may act as a processing unit for audio data, enabling advanced signal routing, filtering, and real-time processing across the distributed audio network. For example, master transceiver 252 may be implemented as a node on master bus 208, facilitating bidirectional communication of both audio and control signals between the central unit and downstream nodes. The DSP may receive audio signals from the central unit and/or master transceiver and process these signals according to predefined logic states, which may include channel assignment, gain adjustment, noise reduction, and dynamic routing based on the current network topology.

The DSP may be further capable of adapting its processing pipeline in response to changes in node connectivity, such as the addition or removal of a removable sub node, thereby helping provide uninterrupted audio playback and good system performance. Audio and control signals may be communicated through the master transceiver to other nodes, including peripheral devices such as microphones, speakers, and sensors, with the DSP dynamically managing signal flow and operational parameters to maintain high-fidelity audio output throughout the vehicle's audio system.

Step 430 of process 400 may include monitoring, via a controller in communication with the central unit, the master transceiver, and the DSP, among others. The controller (e.g., controller 210) may serve as a supervisory entity (aside from the central unit) within the audio system, maintaining continuous oversight of the operational status and connectivity of all nodes on the master bus, including both fixed and removable sub nodes. The controller may receive status information and diagnostic signals from the master transceiver and DSP, enabling it to detect changes in network topology, such as the undocking or reattachment of a removable sub node.

The controller may utilize periodic polling, event-driven notifications, or real-time feedback from error flags and status registers to assess the presence and functionality of each node. Upon detecting a change, such as a sub node becoming disconnected, the controller may initiate a reconfiguration sequence, including, for example, updating system parameters and instructing the DSP to adapt its signal routing and processing logic accordingly. Furthermore, the controller may be responsible for initiating restoration of original audio settings (via the DSP) when a previously removed node is reattached, ensuring seamless reintegration and uninterrupted audio performance.

In an example implementation, the controller may be configured to monitor the operational status and connectivity of nodes on the master bus by interfacing with, for example, an A²B master transceiver (e.g., master transceiver 252). The transceiver may be responsible for collecting and reporting status information and error flags for each enumerated sub node within the network, among other things. Accordingly, the controller's monitoring and supervisory functions may be performed via the master transceiver, rather than through direct communication with individual downstream sub nodes. The controller may utilize, for example, periodic polling, event-driven notifications, and/or real-time feedback from error flags and status registers provided by the master transceiver to assess node presence and functionality. Upon detecting a change in network topology, such as the disconnection or reattachment of a removable sub node, the controller may initiate a reconfiguration sequence (e.g., via DSP 254).

Step 440 of process 400 may include switching the DSP to a first or second state. The controller (e.g., controller 210) may be configured to dynamically manage the operational state of the DSP in response to changes in the network topology, such as the connection status of removable sub nodes. The DSP may be programmed with multiple predefined control logic states, each corresponding to a distinct configuration for audio signal routing, processing parameters, and channel assignments. The DSP may be configured to distribute and communicate audio signals based on a first state of the audio configuration. For example, if the removable sub node is undocked or disconnected, the controller may cause the DSP to switch to a second state, reconfiguring the system to exclude the absent node and adjust audio processing accordingly. When the controller detects that a removable sub node is reconnected, it may instruct the DSP to transition back to the first state, which may activate specific signal paths and processing routines optimized for the full network. For example, this state management may be accomplished by loading precompiled logic branches or parameter sets into the DSP's memory, enabling rapid and deterministic transitions between operational modes without requiring a full system reboot or manual intervention. Furthermore, the controller may utilize diagnostic feedback, such as error flags or status registers from the master transceiver, to inform state selection and guarantee reliable operation under varying conditions. The ability to switch between states in real time may ensure that the audio system maintains uninterrupted playback, good performance, and robust fault tolerance, even as nodes are dynamically added or removed from the network.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer-readable media, such as secondary storage devices, for example, hard disks or CD ROM, or other forms of RAM or ROM, USB media, DVD, Blu-ray, 4K Ultra HD Blu-ray, or other optical drive media.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of . Net Framework, . Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. An audio system for a vehicle, the audio system comprising:
a central unit configured to communicate audio signals over at least one bus, the at least one bus comprising a master bus, wherein the master bus comprises a plurality of nodes;
a master transceiver corresponding to a main node of the plurality of nodes;
a digital signal processor (DSP) configured to communicate the audio signals with the master transceiver and a plurality of sub nodes of the plurality of nodes, the plurality of sub nodes comprising a removable sub node; and
a controller in communication with the central unit, the master transceiver, and the DSP, wherein the controller is configured to monitor a connection status of the removable sub node during operation of the audio system,
wherein, in response to the connection status indicating that the removable sub node is connected, the controller is configured to cause the DSP to switch to a first state, and in response to the connection status indicating that the removable sub node is disconnected, the controller is configured to cause the DSP to switch a second state, the first state and the second states corresponding to different configurations for the audio signals communicated by the DSP.

2. The audio system of claim 1, wherein the first state and the second state correspond to different predefined control logic states stored in at least one of the DSP or the controller.

3. The audio system of claim 2, wherein the predefined control logic states are loaded into a memory during system initialization and retained for switching between the first state and the second state during operation of the audio system.

4. The audio system of claim 2, wherein the DSP is configured to implement the predefined control logic states as logic branches within the DSP, each logic branch corresponding to a different network topology.

5. The audio system of claim 2, wherein the controller is configured to select between the first state and the second state using the predefined control logic, based on error flags or status registers received from the master transceiver.

6. The audio system of claim 1, wherein the removable sub node comprises a removable peripheral device.

7. The audio system of claim 6, wherein the removable peripheral device comprises at least one of a speaker, a microphone, or a sensor.

8. The audio system of claim 1, wherein the removable sub node corresponds to a last node in the plurality of nodes.

9. The audio system of claim 1, wherein the removable sub node corresponds to an intermediary node in the plurality of nodes.

10. The audio system of claim 1, wherein the removable sub node comprises a speaker configured for wireless communications.

11. The audio system of claim 1, wherein the first state comprises a first configuration of the DSP for communicating the audio signals with the plurality of sub nodes.

12. The audio system of claim 1, wherein the second state comprises a second configuration of the DSP for communicating the audio signals with the plurality of sub nodes without the removable sub node.

13. The audio system of claim 1, wherein the DSP is configured to switch from the first state to the second state while the audio signals are being actively communicated with one or more of the plurality of sub nodes.

14. The audio system of claim 1, wherein the controller is further configured to:
monitor the plurality of sub nodes;
detect a connection error for at least one sub node; and
cause, in response to the detection, the DSP to automatically reconfigure the audio signals for remaining sub nodes in the plurality of sub nodes.

15. The audio system of claim 1, wherein the controller is further configured to:
in response to a startup of the audio system, determine whether a sub node of the plurality of sub nodes is not present; and
in response to said determine whether a sub node of the of the plurality of sub nodes is not present, prevent communication of the audio signals.

16. The audio system of claim 1, wherein the DSP is configured to communicate directly with the removable sub node to verify a presence of the removable sub node.

17. The audio system of claim 1, wherein the controller is directly linked to the DSP and the master transceiver.

18. The audio system of claim 1, further comprising a first switch configured to connect or disconnect the removable sub node from the master bus.

19. The audio system of claim 1, further comprising a second switch configured to connect or disconnect another sub node of the plurality of sub nodes from the master bus.

20. The audio system of claim 1, further comprising a clock for generating a reference signal,
wherein the reference signal is provided to at least one of the DSP or the controller for coordinating deterministic timing of control signals from the controller and the audio signals between the controller, the DSP, and the master transceiver.

21. The audio system of claim 20, wherein the reference signal is relayed through at least one switch for establishing at least one loopback between any combination of the master transceiver, the DSP, and the controller for synchronizing the audio signals or the control signals.

22. A method for a vehicle audio system, the method comprising:
communicating, via a central unit, audio signals over at least one bus, the at least one bus comprising a master bus, wherein the master bus comprises a plurality of nodes, wherein a main node of the plurality of nodes comprises a master transceiver;
communicating, via a digital signal processor (DSP), the audio signals with the master transceiver and a plurality of sub nodes of the plurality of nodes, the plurality of sub nodes comprising a removable sub node; and
monitoring, via a controller in communication with the central unit, the master transceiver, and the DSP, wherein the controller is configured to monitor a connection status of the removable sub node during operation of the audio system,
wherein, in response to the connection status indicating that the removable sub node is connected, the controller is configured to cause the DSP to switch to a first state, and in response to the connection status indicating that the removable sub node is disconnected, the controller is configured to cause the DSP to switch a second state, the first state and the second states corresponding to different configurations for the audio signals communicated by the DSP.
